(19) United States
(12) Patent Application Publication
(10) Pub. No.: US 2025/0070259 A1
(43) Pub. Date: Feb. 27, 2025

(54) ALL-SOLID-STATE BATTERY AND MANUFACTURING METHOD THEREOF

(71) Applicants: Hyundai Motor Company, Seoul (KR); Kia Corporation, Seoul (KR)

(72) Inventors: Sung Hoo Jung, Changwon (KR); Ga Young Choi, Busan (KR); Gyeong Min Bak, Suwon (KR); Ji Chang Kim, Seoul (KR); Hyun Min Seo, Seoul (KR)

(21) Appl. No.: 18/604,638

(22) Filed: Mar. 14, 2024

(30) Foreign Application Priority Data
Aug. 21, 2023 (KR) 10-2023-0109246

(51) Int. Cl. H01M 10/058; H01M 10/0562

(52) U.S. Cl. CPC H01M 10/058; H01M 10/0562; H01M 2300/008; H01M 2300/0094

(57) ABSTRACT

An all-solid-state battery includes a positive-electrode stack including a positive-electrode and a first external solid electrolyte layer formed on at least one surface of the positive-electrode; and a negative-electrode stack including a negative-electrode and a second external solid electrolyte layer formed on at least one surface of the negative-electrode, wherein the first external solid electrolyte layer of the positive-electrode stack and the second external solid electrolyte layer of the negative-electrode stack face each other and are in contact with each other, wherein the first external solid electrolyte layer and the second external solid electrolyte layer include sulfide-based solid electrolytes having different chemical compositions. Further, a manufacturing method of the battery is provided.

### CROSS-REFERENCE TO RELATED APPLICATION

This application claims under 35 U.S.C. § 119 (a) the benefit of Korean Patent Application No. 10-2023-0109246, filed in the Korean Intellectual Property Office Aug. 21, 2023, the entire contents of which are incorporated herein by reference.

### BACKGROUND

### Technical Field

The present disclosure relates to an all-solid-state battery having a structure in which different types of sulfide-based solid electrolyte layers are in face-to-face contact with each other, and a manufacturing method thereof.

### Background

Currently, unprecedented climate change is occurring all over the world, and thus, efforts to achieve carbon neutrality in each country are continuing to solve these environmental problems. Carbon neutrality means minimizing greenhouse gas emissions and absorbing the emitted greenhouse gases in various ways to reduce actual greenhouse gas emissions to zero. This is ultimately leading to a movement to curb the use of fossil fuels and expand the use of new and renewable energy. In order to utilize the new and renewable energy, energy storage is essential. Batteries may be used as main means of the energy storage. In the case of automobile production, the use of internal combustion engines that use existing fossil fuels is reduced, and the distribution of electric vehicles (EVs) that use batteries is expanded.

Electric vehicles generally use lithium secondary batteries with high energy density. Lithium secondary batteries using liquid organic electrolytes had a problem with heat accumulation inside the battery when the battery is operating at high temperatures, resulting in a very high risk of fire. Therefore, research and development has been actively conducted on all-solid-state batteries that use solid electrolytes to prevent electrolyte leakage and significantly reduce the risk of fire and explosion as an alternative to the conventional lithium secondary battery using liquid organic electrolyte.

Polymer-based solid electrolyte, oxide-based solid electrolyte, and sulfide-based solid electrolyte materials are commonly used as the solid electrolytes. Among these solid electrolyte materials, the polymer-based solid electrolytes are widely used due to their advantages such as low price, material flexibility, high workability, battery stability, and improved energy density due to thinning of an electrolyte layer and a battery. However, due to a weak strength thereof, the polymer-based solid electrolytes may be damaged during the battery manufacturing process. Accordingly, a technology was proposed to improve the mechanical strength thereof by manufacturing a solid electrolyte membrane by combining a porous polymer support and a solid electrolyte with each other. However, in this approach, a large resistance of the porous polymer support causes a decrease in the performance of the all-solid-state battery, and the efficiency of the process for forming a complex of the porous polymer support and the solid electrolyte is lowered.

Accordingly, there is a need to develop technology that may improve the manufacturing process efficiency of the all-solid-state battery while maintaining the excellent performance of the all-solid-state battery.

### SUMMARY

The present disclosure has been made to solve the above-mentioned problems occurring in the preexisting technology while advantages achieved by the preexisting technology are maintained intact.

An exemplary embodiment of the present disclosure provides an all-solid-state battery and a manufacturing method thereof in which each solid electrolyte layer may be formed on each electrode such that physical detachment between the electrodes is prevented, and each solid electrolyte layer with excellent mechanical strength is formed, and, further, different solid electrolyte layers may be respectively formed on the electrodes and contact each other in a face to face manner to improves performance of the all-solid-state battery and secure electrochemical stability at the interface of the electrode-solid electrolyte layer.

The technical problems to be solved by the present disclosure are not limited to the aforementioned problems, and any other technical problems not mentioned herein will be clearly understood from the following description by those skilled in the art to which the present disclosure pertains.

According to one embodiment of the present disclosure, an all-solid-state battery includes a positive-electrode stack including a positive-electrode and a first external solid electrolyte layer formed on at least one surface of the positive-electrode; and a negative-electrode stack including a negative-electrode and a second external solid electrolyte layer formed on at least one surface of the negative-electrode, wherein the first external solid electrolyte layer of the positive-electrode stack and the second external solid electrolyte layer of the negative-electrode stack face each other and are in contact with each other, wherein the first external solid electrolyte layer and the second external solid electrolyte layer include sulfide-based solid electrolytes having different chemical compositions.

The first external solid electrolyte layer and the second external solid electrolyte layer may be in contact with each other so that the first external solid electrolyte layer and the second external solid electrolyte layer may not be mixed with each other and may not be physically separated from each other.

Each of the sulfide-based solid electrolytes comprises a compound having an agyrodite crystal structure.

The positive-electrode may include a positive-electrode active material and a first internal solid electrolyte.

The negative-electrode may include a negative-electrode active material and a second internal solid electrolyte.

Each of the first internal solid electrolyte and the first external solid electrolyte independently comprises a compound represented by a following Chemical Formula 1:

M¹₆₋ₐM²M³_{5-a+b}X_{1+a-2b} [Chemical Formula 1]
wherein in the Chemical Formula 1,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
−1≤a<0.3, −0.2≤b≤0.

Each of the second internal solid electrolyte and the second external solid electrolyte independently may comprise a compound represented by a following Chemical Formula 2:

M¹_{6-c}M²M³_{5-c+d}X_{1+c-2d} [Chemical Formula 2]
where in the Chemical Formula 2,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
0.3≤c≤1, −0.2≤d≤0.2.

The positive-electrode active material may comprise a compound represented by a following Chemical Formula 3:

Li₁₊ₑM⁴ₓM⁵_{y}M⁶_{z}O_{f} [Chemical Formula 3]
where in the Chemical Formula 3,
−0.05≤e≤0.2, 2≤f≤2.02,
0≤x≤1,0≤y≤0.5, 0≤z≤0.5, x+y+z=1,
each of M⁴, M⁵ and M⁶ independently represents at least one selected from a group consisting of Ni, Co, Mn, Na, Mg, Ca, Ti, V, Cr, Cu, Zn, Ge, Sr, Ag, Ba, Zr, Nb, Mo, Al, Ga and B.

The negative-electrode active material may comprise at least one selected from a group consisting of SiOₐ₁ (0<a1≤2), SiCₐ₂ (0<a2≤2), lithium-containing titanium composite oxide (LTO), artificial graphite, and natural graphite.

The positive-electrode may comprise a first internal solid electrolyte, the negative-electrode may comprise a second internal solid electrolyte, the first internal solid electrolyte and the first external solid electrolyte may have the same chemical composition, and the second internal solid electrolyte and the second external solid electrolyte may have the same chemical composition.

According to another embodiment of the present disclosure, a method for manufacturing an all-solid-state battery includes forming a positive-electrode stack including a positive-electrode and a first external solid electrolyte layer disposed on at least one surface of the positive-electrode; forming a negative-electrode stack including a negative-electrode and a second external solid electrolyte layer disposed on at least one surface of the negative-electrode; and contacting the first external solid electrolyte layer of the positive-electrode stack and the second external solid electrolyte layer of the negative-electrode stack with each other so as to face each other, and rolling the positive-electrode stack and the negative-electrode stack, wherein the first external solid electrolyte layer and the second external solid electrolyte layer include sulfide-based solid electrolytes having different chemical compositions.

The first external solid electrolyte layer and the second external solid electrolyte layer may be in contact with each other so that the first external solid electrolyte layer and the second external solid electrolyte layer are not mixed with each other and are not physically separated from each other.

Each of the sulfide-based solid electrolytes may comprise a compound having an agyrodite crystal structure.

The positive-electrode may comprise a positive-electrode active material and a first internal solid electrolyte.

The negative-electrode may comprise a negative-electrode active material and a second internal solid electrolyte.

The forming of the positive-electrode stack may comprise applying and drying a slurry for forming the first external solid electrolyte layer on the at least one surface of the positive-electrode. The slurry may comprise a first external solid electrolyte, a binder, and dispersant.

The forming of the negative-electrode stack may comprise applying and drying a slurry for forming the second external solid electrolyte layer on the at least one surface of the negative-electrode. The slurry may comprise a second external solid electrolyte, a binder, and a dispersant.

The drying may be performed at about 50° C. to about 150° C., or the rolling may be performed at a pressure of about 100 to about 600 MPa.

The positive-electrode may comprise a first internal solid electrolyte, the negative-electrode may comprise a second internal solid electrolyte, the first internal solid electrolyte and the first external solid electrolyte may have the same chemical composition, and the second internal solid electrolyte and the second external solid electrolyte may have the same chemical composition.

In another exemplary embodiment, a method for manufacturing an all-solid-state battery is provided. The method may include forming a positive-electrode stack comprising a positive-electrode and a first external solid electrolyte layer disposed on at least one surface of the positive-electrode; forming a negative-electrode stack comprising a negative-electrode and a second external solid electrolyte layer disposed on at least one surface of the negative-electrode; contacting the first external solid electrolyte layer and the second external solid electrolyte layer with each other so as to face each other; and rolling the positive-electrode stack and the negative-electrode stack.

The first external solid electrolyte layer and the second external solid electrolyte layer may comprise sulfide-based solid electrolytes having different chemical compositions.

The positive-electrode may comprise a first internal solid electrolyte,

The negative-electrode may comprise a second internal solid electrolyte.

The first internal solid electrolyte and the first external solid electrolyte may have the same chemical composition,

The second internal solid electrolyte and the second external solid electrolyte may have the same chemical composition.

The forming of the positive-electrode stack may comprise applying and drying a slurry for forming the first external solid electrolyte layer on the at least one surface of the positive-electrode.

The forming of the negative-electrode stack may comprise applying and drying a slurry for forming the second external solid electrolyte layer on the at least one surface of the negative-electrode.

In another aspect, a vehicle is provided that comprises a battery as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram schematically showing a manufacturing process of an all-solid-state battery according to one embodiment of the present disclosure;

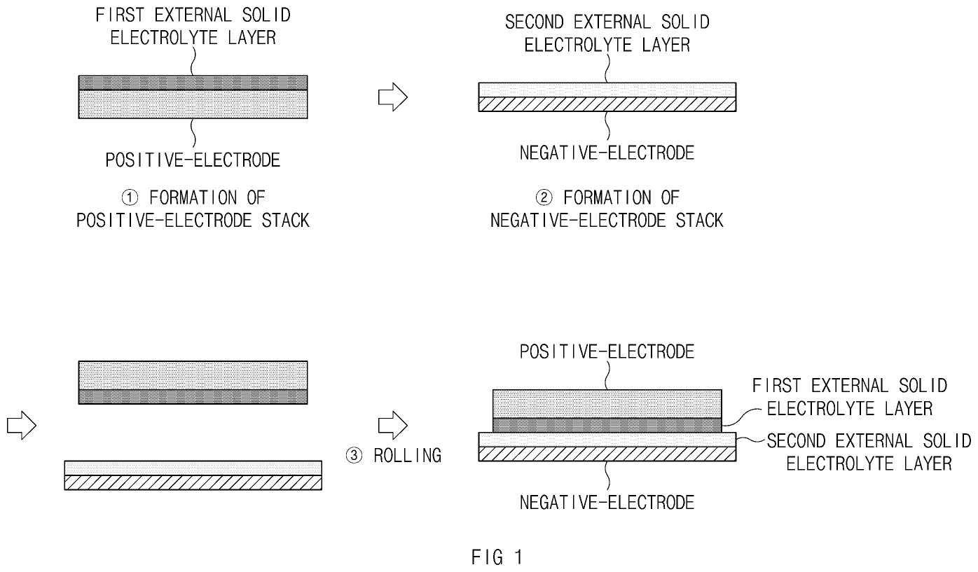

FIG. 2 is a flowchart showing a manufacturing method of an all-solid-state battery according to one embodiment of the present disclosure;

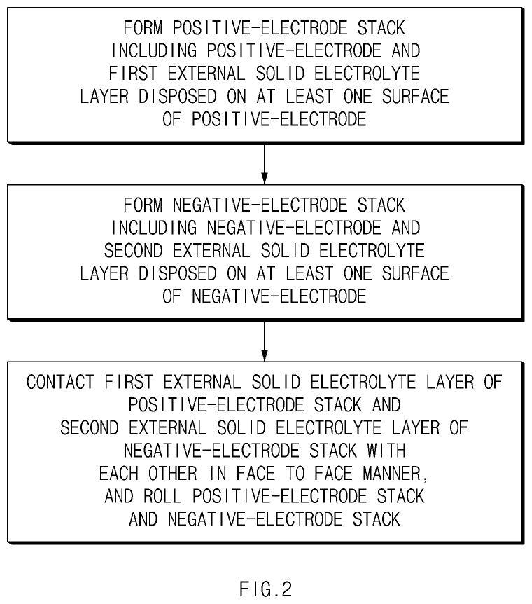

FIG. 3 shows a charge/discharge profile of an all-solid-state battery according to each of Present Example 1 and Comparative Examples 1 to 3;

FIG. 4 shows capacity change as a cycle progresses of an all-solid-state battery according to each of Present Example 1 and Comparative Examples 1 to 3.

### DETAILED DESCRIPTION

A term “all-solid-state battery” as used herein includes a rechargeable battery that includes an electrolyte in a solid state for transferring ions between the electrodes of the battery. In aspects, the battery can be a rechargeable battery that includes an electrolyte in a solid state for transferring ions between the electrodes of the battery. In aspects, the battery can be a secondary battery.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, an all-solid-state battery and a manufacturing method thereof will be described in detail so that those skilled in the art may easily carry out the all-solid-state battery and the manufacturing method thereof.

An all-solid-state battery according to one embodiment of the present disclosure includes a positive-electrode stack including a positive-electrode and a first external solid electrolyte layer formed on at least one surface of the positive-electrode; and a negative-electrode stack including a negative-electrode and a second external solid electrolyte layer formed on at least one surface of the negative-electrode, wherein the first external solid electrolyte layer of the positive-electrode stack and the second external solid electrolyte layer of the negative-electrode stack face each other and are in contact with each other, wherein the first external solid electrolyte layer and the second external solid electrolyte layer include sulfide-based solid electrolytes having different chemical compositions.

The first external solid electrolyte layer of the positive-electrode stack and the second external solid electrolyte layer of the negative-electrode stack may be in contact with each other in a physically inseparable (non-detachable) manner with each other. That is, after manufacturing the positive-electrode on which the first external solid electrolyte layer has been formed and the negative-electrode on which the second external solid electrolyte layer has been formed separately, the first external solid electrolyte layer and the second external solid electrolyte layer may be brought into contact with each other so as to face each other. Thus, the first external solid electrolyte layer and the second external solid electrolyte layer respectively formed on one surface of the positive-electrode and the negative-electrode bond to each other so as to maintain a sufficient bonding strength therebetween such that the first external solid electrolyte layer and the second external solid electrolyte layer are not physically separated (detached) from each other and maintain independent shapes and components thereof without mixing with each other.

The sulfide-based solid electrolyte may include a compound having an agyrodite crystal structure. In particular, lithium ion conductivity may be maximized in a state in which a substitution percentage of group 17 elements at 4a and 4c sites in the agyrodite crystal structure is maximized.

The positive-electrode may include a positive-electrode active material and a first internal solid electrolyte.

Each of the first internal solid electrolyte and the first external solid electrolyte may independently include a compound represented by a following Chemical Formula 1:

M¹₆₋ₐM²M³_{5-a+b}X_{1+a-2b} [Chemical Formula 1]
wherein in the Chemical Formula 1,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
−1≤a<0.3, −0.2≤b≤0.

In one example, the positive-electrode active material may include a compound represented by a following Chemical Formula 2:

Li_{1+c}M⁴ₓM⁵_{y}M⁶_{z}O_{d} [Chemical Formula 2]
wherein in the Chemical Formula 2,
−0.05≤c≤0.2, 2≤d≤2.02,
0≤x≤1, 0≤y≤0.5, 0≤z≤0.5, x+y+z=1,
each of M⁴, M⁵ and M⁶ independently represents at least one selected from a group consisting of Ni, Co, Mn, Na, Mg, Ca, Ti, V, Cr, Cu, Zn, Ge, Sr, Ag, Ba, Zr, Nb, Mo, Al, Ga and B.

The positive-electrode may be manufactured by coating a slurry for a positive-electrode including the positive-electrode active material, a first internal solid electrolyte, a binder, a conductive material, a dispersant, and a solvent on a positive-electrode current collector.

The binder may include one or more selected from a group consisting of, for example, polyvinylidene fluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, fluororubber, and copolymers thereof.

The conductive material may include a conductive material such as graphite such as natural graphite or artificial graphite; carbon black such as acetylene black, Ketjen black, channel black, furnace black, lamp black, and thermal black; conductive fibers such as carbon fiber and metal fiber, metal powders such as carbon fluoride, aluminum, and nickel powder, conductive whiskers such as zinc oxide or potassium titanate; conductive metal oxide such as titanium oxide; and polyphenylene derivatives. However, the present disclosure is not necessarily limited thereto. The conductive material may include any material as long as the material has conductivity without causing chemical change in the battery.

The dispersant may be an aqueous dispersant or an organic dispersant such as N-methyl-2-pyrrolidone (NMP).

The solvent may include, for example, one selected from a group consisting of toluene, xylene, naphtha, benzene, chlorobenzene, and mixed solvents thereof. However, the present disclosure is not necessarily limited thereto.

The positive-electrode current collector may include, for example, stainless steel, aluminum, nickel, titanium, firing-treated carbon, or aluminum or stainless steel surface-treated with carbon, nickel, titanium, silver, etc.

The negative-electrode may include a negative-electrode active material and a second internal solid electrolyte.

Each of the second internal solid electrolyte and the second external solid electrolyte may independently include a compound represented by a following Chemical Formula 3:

M¹₆₋ₑM²M³_{5+e+f}X_{1+e+2f} [Chemical Formula 3]
where in the Chemical Formula 3,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
0.3≤e≤1, −0.2≤f≤0.2.

In one example, the negative-electrode active material may include at least one selected from a group consisting of SiOₐ₁ (0<a1≤2), SiCₐ₂ (0<a2≤2), lithium-containing titanium composite oxide (LTO), artificial graphite, and natural graphite.

The lithium-containing titanium composite oxide may include at least one selected from a group consisting of Li₄Ti₅O₁₂, Li_{0.8}Ti_{2.2}O₄, Li₈Ti₄O₁₂ and LiTi₂O₄.

The negative-electrode may be manufactured by coating a slurry for a negative-electrode including the negative-electrode active material, a second internal solid electrolyte, a binder, a conductive material, a dispersant, and a solvent on a negative-electrode current collector.

The binder, the conductive material, the dispersant, and the solvent may be the same as those as described with reference to the positive-electrode.

The negative-electrode current collector may include, for example, copper, stainless steel, aluminum, nickel, titanium, firing-treated carbon, copper or stainless steel surface-treated with carbon, nickel, titanium, silver, etc., aluminum-cadmium alloy, etc.

The all-solid-state battery according to the present disclosure has the positive-electrode stack includes the positive-electrode stack including the positive-electrode and the first external solid electrolyte layer formed on at least one surface of the positive-electrode; and the negative-electrode stack including the negative-electrode and the second external solid electrolyte layer formed on at least one surface of the negative-electrode, wherein the positive-electrode stack and the negative-electrode stack are manufactured independently, and then bond to each other. Thus, physical detachment between each electrode and each external solid electrolyte layer may be suppressed despite change in a volume of the electrode that occur under application of external shock thereto or during charging and discharging. This is not the case for a conventional all-solid-state battery in an electrode-solid electrolyte layer-an electrode are sequentially stacked and then the stack is rolled. Specifically, when forming the first external solid electrolyte layer on the positive-electrode and the second external solid electrolyte layer on the negative-electrode, the first external solid electrolyte layer and the second external solid electrolyte layer adhere to the positive-electrode and the negative-electrode respectively via the binder in a process of drying the slurry for the positive-electrode and the slurry for the negative-electrode. Thus, the physical detachment therebetween may be prevented.

In addition, the first external solid electrolyte layer of the positive-electrode stack and the second external solid electrolyte layer of the negative-electrode stack have layer structures in a form of a thin film including the sulfide-based solid electrolytes with different chemical compositions, respectively, while facing each other and contacting each other. Thus, in contrast to a case where solid electrolyte in a slurry state is applied to each electrode and then is subjected to a rolling process, the components of the solid electrolyte layers with the different chemical compositions may not be mixed with each other and may independently maintain their own chemical compositions after rolling. More specifically, in accordance with the present disclosure, the first external solid electrolyte layer of the positive-electrode stack includes a sulfide-based solid electrolyte that is stable in a positive-electrode operating voltage range of about 2.5 to 4.3V. The second external solid electrolyte layer of the negative-electrode stack includes a sulfide-based solid electrolyte that is stable in a negative-electrode operating voltage range of approximately 0 to 1.0V. Thus, a stability at an interface between the positive-electrode and the negative-electrode may be improved, which not only suppresses side reactions at each interface, but also effectively reduces ion transfer resistance. On the contrary, in a preexisting technology of applying a type of a solid electrolyte into between the positive-electrode and the negative-electrode to form a stack and rolling the stack. In this regard, the stability of the solid electrolyte is required over a wide voltage range ranging from about 0 to 4.5V. However. In the preexisting technology, it is quite difficult for the sulfide-based solid electrolyte to maintain stability in the above voltage range, so that side reactions tend to occur at the electrode interface, which leads to a decrease in the performance of the all-solid-state battery.

A manufacturing method of an all-solid-state battery according to another embodiment of the present disclosure includes forming a positive-electrode stack including a positive-electrode and a first external solid electrolyte layer disposed on at least one surface of the positive-electrode; forming a negative-electrode stack including a negative-electrode and a second external solid electrolyte layer disposed on at least one surface of the negative-electrode; and contacting the first external solid electrolyte layer of the positive-electrode stack and the second external solid electrolyte layer of the negative-electrode stack with each other so as to face each other, and rolling the positive-electrode stack and the negative-electrode stack, wherein the first external solid electrolyte layer and the second external solid electrolyte layer include sulfide-based solid electrolytes having different chemical compositions.

First, a step is performed to form the positive-electrode stack in which the first external solid electrolyte layer is disposed on at least one surface of the positive-electrode.

The positive-electrode may include the positive-electrode active material and the first internal solid electrolyte.

Each of the first internal solid electrolyte and the first external solid electrolyte may each independently include a compound represented by the following Chemical Formula 1:

M¹₆₋ₐM²M³_{5-a+b}X_{1+a-2b} [Chemical Formula 1]
wherein in the Chemical Formula 1,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
−1≤a<0.3, −0.2≤b≤0.

The positive-electrode active material may include the compound represented by the following Chemical Formula 2:

Li_{1+c}M⁴ₓM⁵_{y}M⁶_{z}O_{d} [Chemical Formula 2]
wherein in the Chemical Formula 2,
−0.05≤c≤0.2, 2≤d≤2.02,
0≤x≤1, 0≤y≤0.5, 0≤z≤0.5, x+y+z=1,
each of M⁴, M⁵ and M⁶ independently represents at least one selected from a group consisting of Ni, Co, Mn, Na, Mg, Ca, Ti, V, Cr, Cu, Zn, Ge, Sr, Ag, Ba, Zr, Nb, Mo, Al, Ga and B.

The positive-electrode may be manufactured by coating a slurry for a positive-electrode including the positive-electrode active material, a first internal solid electrolyte, a binder, a conductive material, a dispersant, and a solvent on a positive-electrode current collector. Specifically, the positive-electrode active material, the first internal solid electrolyte, the binder, the conductive material, and the dispersant may be dispersed in a solvent to prepare the slurry for forming the positive-electrode, and then the slurry may be applied on the positive-electrode current collector and may be dried.

The binder may include one or more selected from a group consisting of, for example, polyvinylidene fluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, fluororubber, and copolymers thereof.

The conductive material may include a conductive material such as graphite such as natural graphite or artificial graphite; carbon black such as acetylene black, Ketjen black, channel black, furnace black, lamp black, and thermal black; conductive fibers such as carbon fiber and metal fiber, metal powders such as carbon fluoride, aluminum, and nickel powder; conductive whiskers such as zinc oxide or potassium titanate; conductive metal oxide such as titanium oxide; and polyphenylene derivatives. However, the present disclosure is not necessarily limited thereto. The conductive material may include any material as long as the material has conductivity without causing chemical change in the battery.

The dispersant may be an aqueous dispersant or an organic dispersant such as N-methyl-2-pyrrolidone (NMP).

The solvent may include, for example, one selected from a group consisting of toluene, xylene, naphtha, benzene, chlorobenzene, and mixed solvents thereof. However, the present disclosure is not necessarily limited thereto.

The positive-electrode current collector may include, for example, stainless steel, aluminum, nickel, titanium, firing-treated carbon, or aluminum or stainless steel surface-treated with carbon, nickel, titanium, silver, etc.

The slurry may be applied using known application methods such as slot die coating, doctor blade method, dip method, reverse roll method, direct roll method, gravure method, extrusion method, and brush coating.

In addition, the drying may be performed in a natural drying, hot air drying, cold air drying, blow drying, or heat drying manner to volatilize the solvent. However, the present disclosure is not limited thereto. The drying may be performed in any scheme as long as the scheme evaporates the solvent from the slurry to obtain a solidified positive-electrode.

The drying may be performed at 50° C. to 150° C.

Forming the positive-electrode stack may include applying and drying the slurry for forming the first external solid electrolyte layer including the first external solid electrolyte, binder, and the dispersant on the at least one surface of the positive-electrode. Specifically, the first external solid electrolyte, the binder, and the dispersant may be dispersed in the solvent to prepare the slurry for forming the positive-electrode stack, and then the slurry may be applied to the at least one surface of the positive-electrode and may be dried.

The binder, the dispersant, and the solvent may be the same as those previously described in the positive-electrode manufacturing method.

The method of applying the slurry for forming the first external solid electrolyte layer to the at least one surface of the positive-electrode is not particularly limited, and may be performed in the same manner as that of applying the slurry for forming the positive-electrode on the positive-electrode current collector.

The drying in the manufacturing of the positive-electrode stack may be performed in the same drying scheme as that in the manufacturing of the positive-electrode and under the same condition as that in the manufacturing of the positive-electrode.

Next, a step is performed to form the negative-electrode stack in which the second external solid electrolyte layer is disposed on the at least one surface of the negative-electrode.

The negative-electrode may include the negative-electrode active material and the second internal solid electrolyte.

Each of the second internal solid electrolyte and the second external solid electrolyte may independently include a compound represented by the following Chemical Formula 3:

M¹₆₋ₑM²M³_{5+e+f}X_{1+e+2f} [Chemical Formula 3]
where in the Chemical Formula 3,
M¹ represents at least one selected from a group consisting of Li, Na, K, Rb, Cs, Mg, Ca, Sr, Ba and mixtures thereof,
M2 represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
0.3≤e≤1, −0.2≤f≤0.2.

In one example, the negative-electrode active material may include at least one selected from a group consisting of SiOₐ₁ (0<a1≤2), SiCₐ₂ (0<a2≤2), lithium-containing titanium composite oxide (LTO), artificial graphite, and natural graphite.

The lithium-containing titanium composite oxide may include at least one selected from a group consisting of Li₄Ti₅O₁₂, Li_{0.8}Ti_{2.2}O₄, Li₈Ti₄O₁₂ and LiTi₂O₄.

The negative-electrode may be manufactured by coating a slurry for a negative-electrode including the negative-electrode active material, a second internal solid electrolyte, a binder, a conductive material, a dispersant, and a solvent on a negative-electrode current collector. Specifically, a slurry for forming a negative-electrode may be prepared by dispersing the negative-electrode active material, the second internal solid electrolyte, binder, the conductive material, and the dispersant in the solvent. Then, the slurry may be applied on the negative-electrode current collector and may be dried to manufacture the negative-electrode.

The binder, the conductive material, the dispersant, and the solvent may be the same as those as described with reference to the method for manufacturing the positive-electrode.

The negative-electrode current collector may include, for example, copper, stainless steel, aluminum, nickel, titanium, firing-treated carbon, copper or stainless steel surface-treated with carbon, nickel, titanium, silver, etc., aluminum-cadmium alloy, etc.

The application and the drying of the slurry may be performed in the same manners as those in the positive-electrode manufacturing method.

Forming the negative-electrode stack may include applying and drying a slurry for forming the second external solid electrolyte layer including the second external solid electrolyte, the binder, and the dispersant on the at least one surface of the negative-electrode. Specifically, the second external solid electrolyte, the binder, and the dispersant may be dispersed in the solvent to prepare the slurry for forming the negative-electrode stack, and then the slurry may be applied to the at least one surface of the negative-electrode and may be dried.

The binder, the dispersant, and the solvent may be the same as previously described in the negative-electrode manufacturing method.

The application and the drying of the slurry for forming the second external solid electrolyte layer may be performed in the same manners as those in the formation step of the positive-electrode stack.

After forming the positive-electrode stack and the negative-electrode stack on the positive-electrode and the negative-electrode, respectively, a step of contacting the first external solid electrolyte layer of the positive-electrode stack and the second external solid electrolyte layer of the negative-electrode stack with each other so as to face each other may be carried out. Then, the positive-electrode stack and the negative-electrode stack may be subjected to a rolling process.

The rolling may be performed at a pressure of 100 to 600 MPa, preferably 200 to 550 MPa, and more preferably 400 to 500 MPa.

The rolling may be performed in a known scheme such as compaction, roll press, or isostatic compaction.

In this way, the method separately manufactures the positive-electrode stack including the positive-electrode and the first external solid electrolyte layer formed on at least one surface of the positive-electrode; and the negative-electrode stack including the negative-electrode and the second external solid electrolyte layer formed on at least one surface of the negative-electrode, and contacts the first external solid electrolyte layer and the second external solid electrolyte layer with each other in a face to face manner, and rolls the positive-electrode stack and the negative-electrode stack to manufacture the all-solid-state battery according to the present disclosure. Thus, physical detachment between each electrode and each external solid electrolyte layer may be suppressed despite change in a volume of the electrode that occur under application of external shock thereto or during charging and discharging of the battery.

In particular, the first external solid electrolyte layer of the positive-electrode stack and the second external solid electrolyte layer of the negative-electrode stack may be formed in a form of a thin film on the positive-electrode and the negative-electrode and may include the sulfide-based solid electrolytes with different chemical compositions, respectively, and may contact each other in the face to face manner, and the rolling process may be applied thereto. Thus, the components of the solid electrolyte layers with the different chemical compositions may not be mixed with each other and may independently maintain their own chemical compositions after rolling. Accordingly, electrochemical stability may be secured at the interface between each external solid electrolyte layer and each electrode. Specifically, when forming the first external solid electrolyte layer on the positive-electrode and the second external solid electrolyte layer on the negative-electrode, the first external solid electrolyte layer and the second external solid electrolyte layer adhere to the positive-electrode and the negative-electrode respectively via the binder in a process of drying the slurry for the positive-electrode and the slurry for the negative-electrode. Thus, the physical detachment therebetween may be prevented.

Additionally, after the rolling process, the first external solid electrolyte layer of the positive-electrode stack and the second external solid electrolyte layer of the negative-electrode stack may be in contact with each other in an inseparable manner from each other.

The first external solid electrolyte layer of the positive-electrode stack and the second external solid electrolyte layer of the negative-electrode stack may include the sulfide-based solid electrolytes having different chemical compositions. The sulfide-based solid electrolyte may include a compound having an agyrodite crystal structure.

Hereinafter, the present disclosure will be described in more detail through Examples. However, these Examples are only intended to aid understanding of the present disclosure, and the scope of the present disclosure is not limited to these Examples in any way.

### <Present Example 1> Manufacturing 1 of All-Solid-State Battery

Li₆PS₅Cl as the solid electrolyte contained in the positive-electrode (the first internal solid electrolyte), LiNi_{0.8}CO_{0.1}Mn_{0.1}O₂ as the positive-electrode active material, carbon black as the conductive material, and butadiene rubber as the binder were mixed with each other in a solvent o-xylene to prepare a slurry for forming a positive-electrode. The slurry was applied to an aluminum foil as the positive-electrode current collector, using a doctor blade, and was dried at 120° C. for 10 minutes.

Next, Li₆PS₅Cl as the solid electrolyte (the first external solid electrolyte) disposed on the positive-electrode and butadiene rubber as the binder are mixed with each other in o-xylene as the solvent to prepare a slurry. The slurry was applied on the positive-electrode and dried at 120° C. for 10 minutes to form the positive-electrode stack on the positive-electrode. Afterwards, the positive-electrode stack was vacuum dried at 120° C. for 4 hours.

Further, Li_{5.4}PS_{4.4}Cl_{1.6} as the solid electrolyte contained in the negative-electrode (the second internal solid electrolyte), silicon-graphite composite as the negative-electrode active material, and butadiene rubber as the binder were mixed with each other in the solvent o-xylene to prepare a slurry for forming a negative-electrode. The slurry was applied to a nickel foil as the negative-electrode current collector, using a doctor blade, and then dried at 120° C. for 10 minutes.

Next, Li_{5.4}PS_{4.4}Cl_{1.6} as the solid electrolyte (the second external solid electrolyte) disposed on the negative-electrode and butadiene rubber as the binder are mixed with each other in o-xylene as the solvent to prepare a slurry. The slurry was applied on the negative-electrode and dried at 120° C. for 10 minutes to form the negative-electrode stack on the negative-electrode. Afterwards, the negative-electrode stack was vacuum dried at 120° C. for 4 hours.

The negative-electrode on which the negative-electrode stack had been formed was oriented so that the negative-electrode stack faces upwardly. The positive-electrode on which the positive-electrode stack had been formed was stacked on the negative-electrode so that the positive-electrode stack faces the negative-electrode stack. Afterwards, a rolling process at 90° C. and 450 MPa using a warm isotactic press was applied thereto. In this way, an all-solid-state battery was manufactured.

### <Present Example 2> Manufacturing 2 of All-Solid-State Battery

An all-solid-state battery was manufactured in the same manner as Present Example 1, except that not Li₆PS₅Cl but Li_{5.4}PS_{4.4}Cl_{1.6} was used as the first external solid electrolyte in the positive-electrode stack.

### <Present Example 3> Manufacturing 3 of All-Solid-State Battery

An all-solid-state battery was manufactured in the same manner as Present Example 1, except that not Li₆PS₅Cl but Li_{5.7}PS_{4.7}Cl_{1.3} was applied to the positive-electrode stack.

### <Comparative Example 1> Manufacturing of All-Solid-State Battery 4

An all-solid-state battery was manufactured in the same manner as Present Example 1, except that the first external solid electrolyte was not included in the positive-electrode stack.

### <Experimental Example 1> Evaluation of Charging and Discharging Performance of All-Solid-State Battery

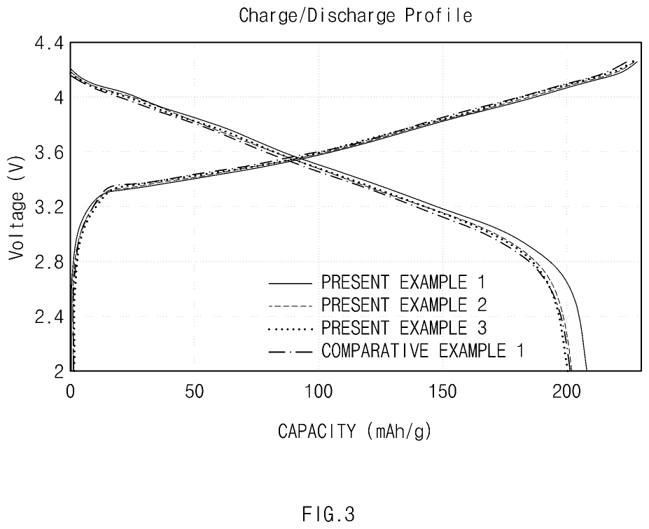

To evaluate the charging and discharging performance of the all-solid-state battery, charging and discharging was performed once at 30° C. at 0.05 C-rate on the all-solid-state battery according to each of Present Example 1 to Present Example 3 and Comparative Example 1. As a result, a voltage profile is shown in FIG. 3 and a following Table 1. A resistance value was calculated after discharging the battery at 0.33C for 10 seconds from a 50% charged state (DC-IR).

TABLE 1

| | | | | Average | |
|---|---|---|---|---|---|
| | Charge | Discharge | | discharge | |
| | capacity | capacity | Efficiency | voltage | Resistance |
| Example | (mAh/g) | (mAh/g) | (%) | (V) | (Ω) |
| Present | 227.6 | 208.0 | 91.4 | 3.46 | 6.2 |
| Example 1 | | | | | |
| Present | 227.0 | 200.7 | 88.4 | 3.46 | 9.5 |
| Example 2 | | | | | |
| Present | 226.6 | 201.5 | 88.9 | 3.46 | 8.3 |
| Example 3 | | | | | |
| Comparative | 223.5 | 200.9 | 89.9 | 3.43 | 11.0 |
| Example 1 | | | | | |

As a result of the experiment, it was identified that in the all-solid-state battery according to each of Present Example 1 to Present Example 3 using the positive-electrode including the first external solid electrolyte layer, not only the charge capacity, the discharge capacity, and the average discharge voltage were excellent, but also the resistance value was low, compared to the all-solid-state battery according to Comparative Example 1 free of the first external solid electrolyte layer on the positive-electrode. This is because the first external solid electrolyte layer formed on one surface of the positive-electrode and the second external solid electrolyte layer formed on one surface of the negative-electrode maintain close contact with the positive-electrode and the negative-electrode, respectively, even when the charging and discharging process progresses.

Further, based on a comparing result of Present Example 1 with Present Example 2 and Present Example 3, an effect of a type of the first external solid electrolyte applied on the positive-electrode may be identified. Specifically, Present Example 1 in which Li₆PS₅Cl is applied to the first external solid electrolyte layer formed on one surface of the positive-electrode exhibits excellent charge/discharge efficiency and a low resistance value, compared to Present Examples 2 and 3 in which Li_{5.4}PS_{4.4}Cl_{1.6} and Li_{5.7}PS_{4.7}Cl_{1.3} are applied thereto, respectively. In other words, it is identified that when considering that in all of Present Example 1 to Present Example 3, Li_{5.4}PS_{4.4}Cl_{1.6} is commonly used as the second external solid electrolyte formed on one surface of the negative-electrode, the all-solid-state battery exhibits the best performance when the first external solid electrolyte layer made of Li₆PS₅Cl was in contact with the positive-electrode. This is because the oxidation stability of Li₆PS₅Cl at the interface with the positive-electrode is excellent, while the reduction stability of Li_{5.4}PS_{4.4}Cl_{1.6} at the interface with the negative-electrode is excellent.

### <Experimental Example 2> Evaluation of Lifespan Characteristics of All-Solid-State Battery

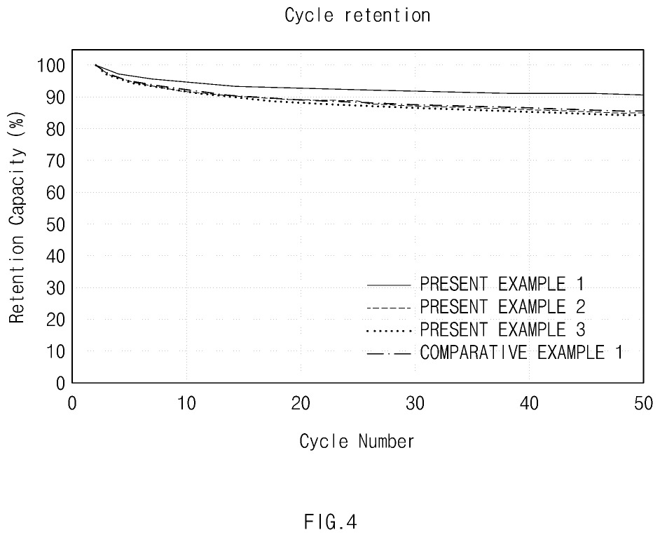

In order to evaluate the lifespan characteristics of the all-solid-state battery, the capacity during the cycle progress was measured on the all-solid-state battery according to each of Present Example 1 to Present Example 3 and Comparative Example 1, and is shown in a following Table 2. A retention capacity as the cycle progresses is shown in FIG. 4. Initial charging and discharging were performed at a 0.1 C-rate, and thereafter, charging and discharging were performed at a 0.2 C-rate.

TABLE 2

| | | Average | | |
|---|---|---|---|---|
| | Discharge | discharge | Capacity at 2nd cycle/ | Retention |
| | capacity | voltage | Capacity at 1st cycle | capacity |
| Example | (mAh/g) | (V) | (%) | (%) |
| Present | 179.0 | 3.35 | 86.0 | 90.8 |
| Example 1 | | | | |
| Present | 158.2 | 3.28 | 78.8 | 84.9 |
| Example 2 | | | | |
| Present | 163.0 | 3.31 | 80.9 | 84.4 |
| Example 3 | | | | |
| Comparative | 154.5 | 3.22 | 76.9 | 85.6 |
| Example 1 | | | | |

In the all-solid-state battery according to Present Example 1, approximately 90% of an initial capacity (capacity at a second cycle) was maintained after 50 cycles, and thus, excellent retention capacity was secured even after repeated charging and discharging several times, compared to the all-solid-state battery according to Comparative Example 1. In addition, the all-solid-state battery according to Present Example 1 exhibited excellent retention capacity compared to the all-solid-state battery according to Present Example 2 and Present Example 3.

That is, it is identified that in the all-solid-state battery with the stack structure in which the solid electrolyte layer of Li₆PS₅Cl formed on the positive-electrode and the solid electrolyte layer of Li_{5.4}PS_{4.4}Cl_{1.6} formed on the negative-electrode are in contact with each other in a face to face manner, the retention capacity is superior compared to a case where the solid electrolyte layer is not formed on the positive-electrode or the solid electrolyte layer of Li_{5.4}PS_{4.4}Cl_{1.6} or Li_{5.7}PS_{4.7}Cl_{1.3} is formed.

Further, Present Example 1 exhibits the highest capacity ratio at the 0.2 C-rate compared to the 0.05 C-rate. Thus, the capacity at such a high rate is due to the low resistance value as described above.

In the all-solid-state battery of the present disclosure, each solid electrolyte layer is directly on each electrode, thereby preventing physical detachment between the electrode and the solid electrolyte layer due to stable bonding between each electrode and each solid electrolyte layer, and thereby realizing the solid electrolyte layer of the excellent mechanical strength.

In addition, according to the manufacturing method of the all-solid-state battery of the present disclosure, the different solid electrolyte layers are formed on the electrodes and contact each other in the face to face manner. Thus, the electrochemical stability at the interface between the electrode and the solid electrolyte layer may be secured. Thus, the all-solid-state batteries of the high performance may be manufactured at high efficiency.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all-solid-state battery comprising:
a positive-electrode stack comprising a positive-electrode and a first external solid electrolyte layer formed on at least one surface of the positive-electrode; and
a negative-electrode stack comprising a negative-electrode and a second external solid electrolyte layer formed on at least one surface of the negative-electrode,
wherein the first external solid electrolyte layer and the second external solid electrolyte layer face each other and are in contact with each other, and
wherein the first external solid electrolyte layer and the second external solid electrolyte layer comprise sulfide-based solid electrolytes having different chemical compositions.

2. The all-solid-state battery of claim 1, wherein the first external solid electrolyte layer and the second external solid electrolyte layer are in contact with each other so that the first external solid electrolyte layer and the second external solid electrolyte layer are not mixed with each other and are not physically separated from each other.

3. The all-solid-state battery of claim 1, wherein each of the sulfide-based solid electrolytes comprises a compound having an agyrodite crystal structure.

4. The all-solid-state battery of claim 1, wherein the positive-electrode comprises a positive-electrode active material and a first internal solid electrolyte.

5. The all-solid-state battery of claim 1, wherein the negative-electrode comprises a negative-electrode active material and a second internal solid electrolyte.

6. The all-solid-state battery of claim 4, wherein each of the first internal solid electrolyte and the first external solid electrolyte independently comprises a compound represented by a following Chemical Formula 1:
M¹₆₋ₐM²M³_{5-a+b}X_{1+a-2b} [Chemical Formula 1]
wherein in the Chemical Formula 1,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
−1≤a<0.3, −0.2≤b≤0.

7. The all-solid-state battery of claim 5, wherein each of the second internal solid electrolyte and the second external solid electrolyte independently comprises a compound represented by a following Chemical Formula 2:
M¹_{6-c}M²M³_{5-c+d}X_{1+c-2d} [Chemical Formula 2]
where in the Chemical Formula 2,
M¹ represents at least one selected from a group consisting of Li, Na, K, Rb, Cs, Mg, Ca, Sr, Ba and mixtures thereof,
M² represents at least one selected from a group consisting of P, N, Al, Si, Ga, Ge, As, In, Sn, Sb, Pb, Bi and mixtures thereof,
M³ represents S, O or a mixture thereof,
X represents at least one element selected from group 17 elements,
0.3≤c≤1, −0.2≤d≤0.2.

8. The all-solid-state battery of claim 4, wherein the positive-electrode active material comprises a compound represented by a following Chemical Formula 3:
Li₁₊ₑM⁴ₓM⁵_{y}M⁶_{z}O_{f} [Chemical Formula 3]
where in the Chemical Formula 3,
−0.05≤e≤0.2, 2≤f≤2.02,
0≤x≤1, 0≤y≤0.5, 0≤z≤0.5, x+y+z=1,
each of M⁴, M⁵ and M⁶ independently represents at least one selected from a group consisting of Ni, Co, Mn, Na, Mg, Ca, Ti, V, Cr, Cu, Zn, Ge, Sr, Ag, Ba, Zr, Nb, Mo, Al, Ga and B.

9. The all-solid-state battery of claim 5, wherein the negative-electrode active material comprises at least one selected from a group consisting of SiOₐ₁ (0<a1≤2), SiCₐ₂ (0<a2≤2), lithium-containing titanium composite oxide (LTO), artificial graphite, and natural graphite.

10. The all-solid-state battery of claim 1, wherein the positive-electrode comprises a first internal solid electrolyte, wherein the negative-electrode comprises a second internal solid electrolyte, wherein the first internal solid electrolyte and the first external solid electrolyte have the same chemical composition, and wherein the second internal solid electrolyte and the second external solid electrolyte have the same chemical composition.

11. A method for manufacturing an all-solid-state battery, the method comprising:
forming a positive-electrode stack comprising a positive-electrode and a first external solid electrolyte layer disposed on at least one surface of the positive-electrode;
forming a negative-electrode stack comprising a negative-electrode and a second external solid electrolyte layer disposed on at least one surface of the negative-electrode;
contacting the first external solid electrolyte layer and the second external solid electrolyte layer with each other so as to face each other; and
rolling the positive-electrode stack and the negative-electrode stack,
wherein the first external solid electrolyte layer and the second external solid electrolyte layer comprise sulfide-based solid electrolytes having different chemical compositions.

12. The method of claim 11, wherein the first external solid electrolyte layer and the second external solid electrolyte layer are in contact with each other so that the first external solid electrolyte layer and the second external solid electrolyte layer are not mixed with each other and are not physically separated from each other.

13. method of claim 11, wherein each of the sulfide-based solid electrolytes comprises a compound having an agyrodite crystal structure.

14. The method of claim 11, wherein the positive-electrode comprises a positive-electrode active material and a first internal solid electrolyte.

15. The method of claim 11, wherein the negative-electrode comprises a negative-electrode active material and a second internal solid electrolyte.

16. The method of claim 11, wherein the forming of the positive-electrode stack comprises applying and drying a slurry for forming the first external solid electrolyte layer on the at least one surface of the positive-electrode, wherein the slurry comprises a first external solid electrolyte, a binder, and dispersant.

17. The method of claim 16, wherein the forming of the negative-electrode stack comprises applying and drying a slurry for forming the second external solid electrolyte layer on the at least one surface of the negative-electrode, wherein the slurry comprises a second external solid electrolyte, a binder, and a dispersant.

18. The method of claim 17, wherein the drying is performed at about 50° C. to about 150° C., or wherein the rolling is performed at a pressure of about 100 to about 600 MPa.

19. The method of claim 11, wherein the positive-electrode comprises a first internal solid electrolyte, wherein the negative-electrode comprises a second internal solid electrolyte, wherein the first internal solid electrolyte and the first external solid electrolyte have the same chemical composition, and wherein the second internal solid electrolyte and the second external solid electrolyte have the same chemical composition.

20. A method for manufacturing an all-solid-state battery, the method comprising:
forming a positive-electrode stack comprising a positive-electrode and a first external solid electrolyte layer disposed on at least one surface of the positive-electrode;
forming a negative-electrode stack comprising a negative-electrode and a second external solid electrolyte layer disposed on at least one surface of the negative-electrode;
contacting the first external solid electrolyte layer and the second external solid electrolyte layer with each other so as to face each other; and
rolling the positive-electrode stack and the negative-electrode stack,
wherein the first external solid electrolyte layer and the second external solid electrolyte layer comprise sulfide-based solid electrolytes having different chemical compositions,
wherein the positive-electrode comprises a first internal solid electrolyte,
wherein the negative-electrode comprises a second internal solid electrolyte,
wherein the first internal solid electrolyte and the first external solid electrolyte have the same chemical composition,
wherein the second internal solid electrolyte and the second external solid electrolyte have the same chemical composition,
wherein the forming of the positive-electrode stack comprises applying and drying a slurry for forming the first external solid electrolyte layer on the at least one surface of the positive-electrode, and
wherein the forming of the negative-electrode stack comprises applying and drying a slurry for forming the second external solid electrolyte layer on the at least one surface of the negative-electrode.
